(19) United States
(12) Patent Application Publication
(10) Pub. No.: US 2020/0253168 A1
(43) Pub. Date: Aug. 13, 2020

(54) Bee Hive

(71) Applicant: Pictland Ranch and Apiary, LLC, Farmersville, TX (US)

(72) Inventor: Michael J. Pearson, Farmersville, TX (US)

(21) Appl. No.: 16/782,690

(22) Filed: Feb. 5, 2020

Related U.S. Application Data
(60) Provisional application No. 62/802,314, filed on Feb. 7, 2019.

(51) Int. Cl. A01K 47/02; A01K 47/06; A01K 53/00

(52) U.S. Cl. CPC A01K 47/02; A01K 53/00; A01K 47/06

(57) ABSTRACT

Disclosed herein are embodiments and aspects of a bee hive that can include one or more of a hive body, a screen bottom board, and a cover(s). Rabbets can be formed in parallel side walls of the hive body, and the rabbets are configured to hold a top bar and configured to hold a frame. The screen bottom board is connected to the hive body and configured to allow mites to fall out of the bee hive while keeping bees inside the hive body, and sub-boards can be placed in the screen bottom to catch the mites. The covers can cover the top bars and/or frames in the hive body.

### CROSS-REFERENCE TO RELATED APPLICATION

This U.S. non-provisional patent application claims priority to U.S. provisional patent application No. 62/802,314, filed on Feb. 7, 2019, entitled “Bee Hive”, which is incorporated herein by reference in its entirety.

### TECHNICAL FIELD

The present disclosure relates to a bee hive.

### BACKGROUND

Two types of bee hives that are commercially available to bee keepers are the Langstroth hive and the Kenya top bar hive. Additional types of hives are desirable to accommodate different lifestyles and needs for an increasing number of bee keepers in the United States and abroad.

### SUMMARY

Disclosed herein are embodiments and aspects of a bee hive that can be configured to accommodate different lifestyles and needs for bee keepers. The bee hive can include one or more of a hive body, a screen bottom board, and a cover(s). Rabbets can be formed in parallel side walls of the hive body, and the rabbets are configured to hold a top bar and configured to hold a frame. The screen bottom board is connected to the hive body and configured to allow mites to fall out of the bee hive while keeping bees inside the hive body, and sub-boards can be placed in the screen bottom to catch the mites. The covers can cover the top bars and/or frames in the hive body.

### BRIEF DESCRIPTION OF THE DRAWINGS

FIG. 1 is an exploded orthogonal view of an embodiment of the bee hive of the present disclosure.

FIG. 2A is an orthogonal view of an embodiment of the hive body for the disclosed bee hive.

FIG. 2B is a cross-sectional view of the hive body, taken along sight line A-A in FIG. 2A.

FIG. 3A illustrates an orthogonal view of an embodiment of the screen bottom board of the disclosed bee hive.

FIG. 3B is a side view of the screen bottom board of FIG. 3A.

FIG. 3C illustrates an isolated side view of a cross member of the screen bottom board, from a side that is perpendicular to the side shown in FIG. 3B.

FIG. 3D is a top view of the sub-boards used in the screen bottom board of FIG. 3A.

FIG. 3E is a side view of the sub-board of FIG. 3D.

FIG. 4A shows an orthogonal view of the hive body of the bee hive having the inner covers placed on a top thereof.

FIG. 4B shows an orthogonal view of the hive body of the bee hive having a top cover placed over a top of the inner covers of FIG. 4A.

FIG. 5A illustrates an orthogonal view of a migratory cover for the bee hive.

FIG. 5B illustrates a side view of the migratory cover in FIG. 5A.

FIG. 5C illustrates an orthogonal view of the hive body of the bee hive having inner covers installed thereon, and migratory covers on top of the inner covers.

FIG. 6A illustrates an orthogonal view of the hive body of the bee hive having top bars placed therein.

FIG. 6B illustrates an orthogonal view of the hive body of the bee hive having Langstroth frames placed therein.

FIG. 7 is an orthogonal view of the follower board in use in an assembled hive body and screen bottom board.

FIG. 8 is an orthogonal view of the queen excluder in use in an assembled hive body and screen bottom board.

FIG. 9 is an orthogonal view of the division board feeder in use in an assembled hive body and screen bottom board.

FIG. 10 is an orthogonal view of an entrance reducer.

FIGS. 11A and 11B are orthogonal views of the disclosed bee hive having a Langstroth Top Feeder.

FIGS. 12A to 12D illustrate cross sectional views of the bee hive in different configurations with the different covers (top cover, migratory cover, and inner cover), taken along sight line B-B of FIG. 11B.

FIG. 13A shows a front view of support legs for the bee hive, and FIG. 13B shows a side of view of the support legs of FIG. 13A.

FIG. 14 is an orthogonal view of an external entrance feeder used to supply sugar syrup to bees.

### DETAILED DESCRIPTION

Disclosed is a horizontally-oriented hybrid-type bee hive that incorporates the current best standards and beekeeping practices without having to choose a single hive type (e.g., a Langstroth hive or a Kenya top bar hive).

A Langstroth hive has a rectangular cross section, is a rectangular prism in shape, and is oriented with the longest side extending vertically. The Langstroth hive contains one or more Langstroth boxes, each box containing 10 Langstroth frames. The boxes are stacked one on top of another to make the Langstroth hive. A vertical stack of three Langstroth boxes can hold 30 Langstroth frames. Each Langstroth frame sits on a rabbet or groove that is formed (e.g., milled or otherwise machined) into the inside top edge of two parallel sides of the Langstroth box (e.g., the longest sides). The Langstroth hive can have an inner cover that sits on top of the top-most Langstroth box, and the Langstroth hive can also have a telescoping or top cover that is slightly larger than the top of a Langstroth box and has sides that hang over the edge of the top Langstroth box like the eaves of a house. A bee keeper having an existing Langstroth hive can start a new Langstroth hive by placing a Langstroth frame containing bees from an existing Langstroth hive into a box in the new Langstroth hive. A discussion of a Langstroth hive can be found in U.S. Pat. No. 4,135,265.

The Kenya hive, also known as a “top bar hive,” has become popular with bee keepers that have disabilities, use a wheelchair, or lack the strength in their hands, arms, or back needed to lift or manipulate Langstroth boxes (which can weigh up to about 90 pounds when filled with bees, honey, and pollen). A Kenya hive has a trapezoidal cross-section, has a trough-like shape, and is oriented horizontally. Top bars are placed on top of the body structure, so that the ears of each top bar sit on top of two parallel sides of the body structure (e.g., the longest sides). A middle portion of each top bar is exposed to the open space in the body structure, and bees attach honeycomb to the bottom side of each top bar and build the honeycomb in the open space of the body structure. A standard Kenya hive can hold roughly 28 one-piece top bars. The top bars can be covered with a long top cover that may, or may not, provide a weatherproof covering for the Kenya hive, depending on the design.

One problem with having to choose either a Langstroth hive or a Kenya top bar hive is that Langstroth frames are not compatible for use in Kenya top bar hives. For example, bee keepers that want to start a colony of bees in an empty Kenya hive cannot use the Langstroth frames because the Langstroth frames have a rectangular cross-section and will not fit in a Kenya hive due to the trapezoidal cross-section of the Kenya hive. This has led to a market for package bees for bee keepers that want to start a new bee colony in a Kenya hive but do not have a source of bees from another Kenya hive. Package bees are bees obtained from a “package” that contains 3 to 5 pounds of bees and a queen. The package can be a screened box without any frames or honeycomb. In the past, producers of package bees have shipped packages of the package bees to customers, such as bee keepers with a new hive and no other source of bees. The package bees are poured from the package into the empty Kenya hive and then are fed copious amounts of sugar syrup to allow them to start producing wax to make honeycomb. Most package bee producers are east of the Mississippi River, or on the west coast of the USA. In recent years, most of those producers have quit shipping package bees to the Midwest, due to financial losses caused by having to replace package bees that died in transit to the customer, and had to be replaced. Those package bee operations that still ship to the Midwest are increasingly shipping their packages to the customer at the customer's risk, without replacement. The disclosed bee hive can be started with Langstroth style frames (which might be available from local hives) or Kenya top-bar frames, without needing to alter, adapt, or modify the equipment.

Another problem for bee keepers using a Kenya hive is that the honeycomb easily breaks. In a Kenya hive, bees attach the honeycomb to the bottom of a top bar and the honeycomb only has one attachment point. The honeycomb has no other structural contact with the Kenya hive, and is prone to breaking off the top bar(s) of the Kenya hive when handled in a manner that puts stress on the attachment point. In contrast, bees attach the honeycomb to all four internal surfaces of a Langstroth frame. This provides a stable platform for the honeycomb. When the Langstroth frame has a plastic foundation installed in it prior to placing the Langstroth frame in the Langstroth hive, the honeycomb is stable due to it being attached to the inside of the Langstroth frame. The disclosed bee hive can better protect the honeycomb on top bars and/or accommodate both top bars and Langstroth frames, and is vertically oriented like the Langstroth hive.

Another problem for bee keepers using a Kenya hive is that the honeycomb is destroyed to recover the honey. Honeycomb from a traditional Kenya hive cannot be placed in a mechanical honey extractor. The top bars containing honeycomb are removed from the Kenya hive, and the honeycomb is cut off the top bars. The honeycomb is then squeezed in a press or by hand to extract the honey. This is a very messy process. The empty top bars are then placed back into the Kenya hive for the bees to replace the honeycomb that was destroyed. It takes 6-10 pounds of nectar, honey, or sugar syrup to replace one pound of destroyed honeycomb wax. That is a valuable food resource for the bees and requires that they be fed copious amounts of sugar syrup to replenish the honey that was taken, as well as the honeycomb that was destroyed. In Langstroth hives, the Langstroth frames containing honeycomb are removed, the wax capping the honey is removed or punctured and they are placed in a hand cranked or motor driven centrifuge. The spinning of the centrifuge extracts the honey from the Langstroth frames, while leaving the honeycomb relatively intact. The Langstroth frame containing the honeycomb can then be placed back into the hive for reuse by the bees, thereby saving them additional effort to create honeycomb, thereby reducing their efforts. The amount of sugar syrup needed to replenish the honey that was taken is reduced as a result as well. The disclosed bee hive allows a bee keeper to preserve the honeycomb while extracting honey, while not being vertically oriented like the Langstroth hive.

Another problem facing all bee keepers is protecting the bees from mites. In 1987, the problem of Varroa mite infestation of bees in North America became apparent. Varroa mites are a parasitic pest that attaches to bees, reproduces, and can kill a colony in two years if not treated or removed from the hive. The mites are prone to fall off the bees and can reattach themselves to adult bees or bee larvae if allowed to remain inside the hive. U.S. Pat. No. 4,867,731 addresses this situation in Langstroth hives through the use of a removable sliding detector sheet. Currently, Langstroth bottom boards for vertically oriented Langstroth hives are available that use similar sliding sheets under a permanently attached one-eighth inch opening screen. The sheets are often left off to allow the Varroa mites to drop onto the ground where they cannot again infest the bee colony. Most commercially available Kenya hives have solid bottoms, thereby allowing Varroa mites to remain in the Kenya hive to reproduce and further infest the bee colony. Those Kenya hives that have screened bottoms do not incorporate mite trays to allow monitoring of mite levels. The disclosed bee hive has mite control and is not vertically oriented like the Langstroth hive.

Finally, another problem facing bee keepers utilizing a Kenya hive is the bee entrance. The entrances of Kenya hives are often non-adjustable and can vary from manufacturer to manufacturer, so control of the entrance size is non-existent. Langstroth hives typically have a bee entrance which can receive a standard 10-frame Langstroth entrance reducer that allows two different and smaller entrance sizes. The disclosed bee hive can be configured with a bee entrance port that is configured to receive a standard 10-frame Langstroth entrance reducer that allows two different and smaller entrance sizes, while the bee hive is not vertically oriented like the Langstroth hive.

A “colony” or “colonies” as used herein refer to a group or groups of bees such as honeybees.

A “hive” or “bee hive” as used herein refers to the physical structure and components thereof in which a colony of bees lives. A colony of bees may create honeycomb that is physically attached to the physical structure of the bee hive. In some embodiments, reference to “hive” or “bee hive” may include the honeycomb within its scope, while in some other embodiments, reference to “hive” or “bee hive” does not include the honeycomb within its scope.

A “top bar” as used herein refers to top bars used in the bee keeping industry, and configured as an elongate bar of material such as wood on which bees attach honeycomb. An example of a “top bar” described herein has dimensions of a standard Kenya style top bar.

A “frame” as used herein refers to frames used in the bee keeping industry, and configured as an elongate bar and frame (shaped like a picture frame) of material such as wood on inside which bees attach honeycomb. An example of a “frame” described herein has dimensions of a standard Langstroth style frame.

The disclosed bee hive incorporates the ability to use Kenya top bar frames as well as Langstroth frames without the need to alter, adapt, or modify them or the hive box to accommodate them. When a bee colony outgrows its hive, it must be split into two or more smaller colonies in order to prevent the colony from swarming and losing bees. The disclosed bee hive allows Kenya-style top bars to be transferred to the bee hive of the present disclosure readily and easy. As a result, additional hives can be created without the need to alter, adapt, or modify the bee hive or the hive box to accommodate the new colony.

Moreover, the readily available and standard 10-frame Langstroth equipment is compatible with the disclosed bee hive. Syrup feeders such as i) entrance feeders (which are also known as boardman feeders), ii) division board feeders, and iii) top feeders can be used with the disclosed bee hive without having to create or modify feeders for the bee hive. One of the limitations of commercially available Kenya hives is that internal and external syrup feeders for Kenya hives must be fabricated by the user due to their designs and cross-sections.

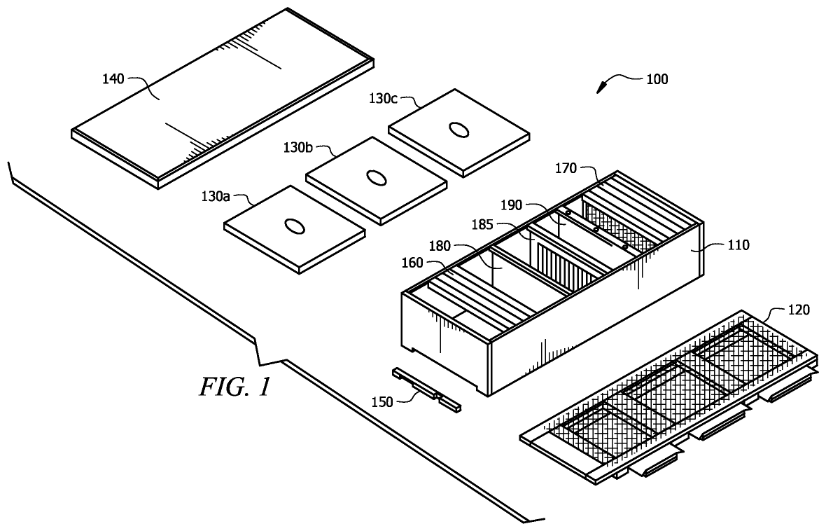

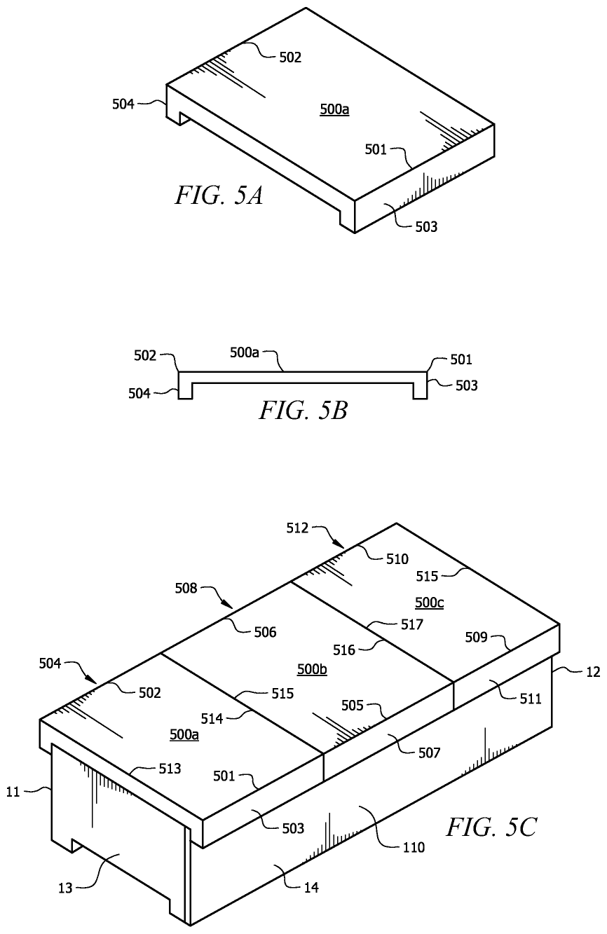

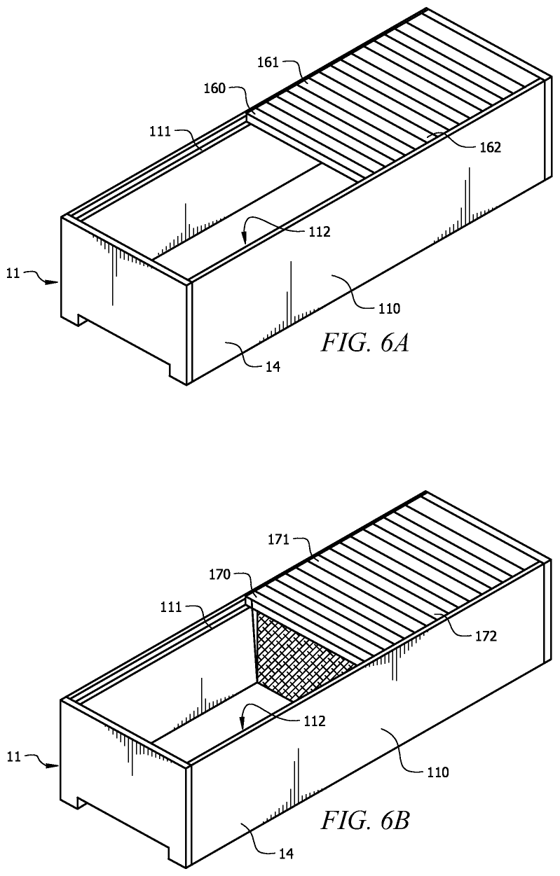

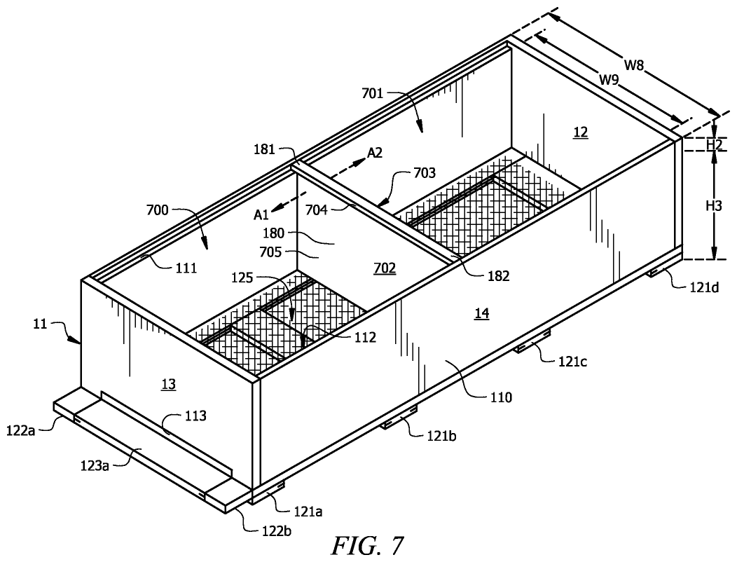

FIG. 1 is an exploded view of an embodiment of the bee hive 100 of the present disclosure. The bee hive 100 can include one or more of a hive body 110, a screen bottom board 120, one or more inner covers 130, a top cover 140 (or alternatively, a plurality of migratory covers discussed for FIGS. 5A-5C), an entrance reducer 150, a Kenya-style top bar 160, a Langstroth-style frame 170, a follower board 180, a queen excluder 185, and a division board feeder 190. Each of these components is described below. The hive body 110 can be connected to the screen bottom board 120 via any manner of connecting the two structures, e.g., nails, brackets, screws, adhesive, welding, or a combination thereof. The one or more inner covers 130 generally rest on top of the hive body 110, and the top cover 130 generally rests on top of the inner covers 130. The entrance reducer 150 is placed in an opening of the hive body 110 (explained in more detail below). The Kenya-style top bar 160, Langstroth-style frame 170, follower board 180, queen excluder 185, and division board feeder 190 are all placeable in the hive body 110 such that the screen bottom board 120 is below the hive body 110 and the inner cover(s) 130 and top cover 140 are above the hive body 110.

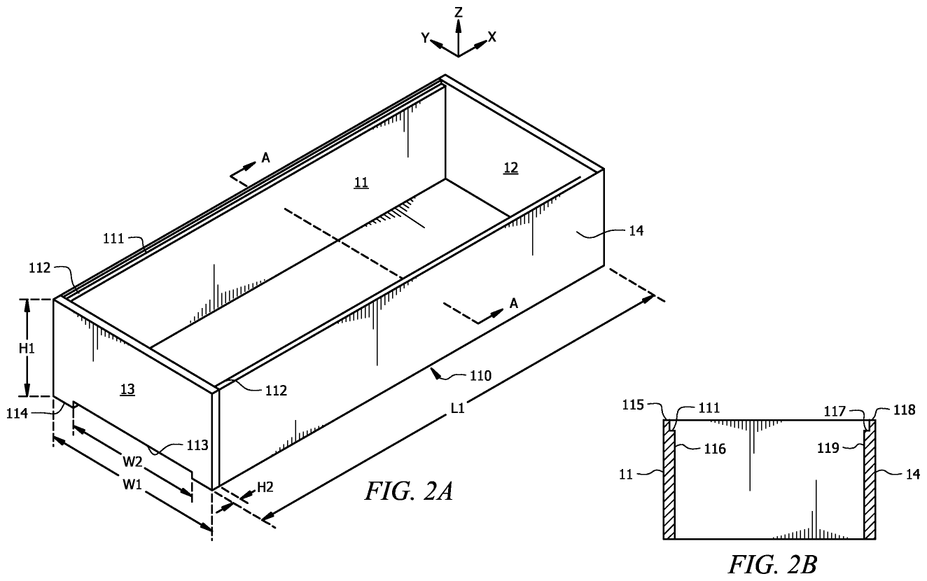

FIG. 2A is an orthogonal view of an embodiment of the hive body 110 for the disclosed bee hive 100. The hive body 110 can also be referred to as the hive body or hive box, and the bee hive 100 of the present disclosure has only one hive body or hive box (in comparison to the multiple boxes used in a Langstroth hive). Also, the hive body 110 is horizontally oriented such that the height H1 of the hive body 110 is less than the length L1 of the hive body 110 (L1 being the length of the long pair of side walls 11 and 14 of the hive body 110), and optionally less than then width W1 of the hive body 110 (W1 being the length of the short pair of side walls 12 and 13 of the hive body 110). The hive body 110 can be considered a box having four side walls, and without a top face and bottom face.

The hive body 110 has a rectangular or square cross section when viewed in a plane of any two the X, Y, and Z dimensions. For dimensions X, Y, and Z oriented as shown in FIG. 2A, the XY plane can have a rectangular cross section or square cross section, the XZ plane can have a rectangular cross section, and the YZ plane can have a rectangular cross section or square cross section. In some embodiments, the XY plane has a rectangular cross section, the XZ plane has a rectangular cross section, and the YZ plane has a rectangular cross section.

In all embodiments, no cross section of the hive body 110 has a trapezoidal shape (a Kenya hive that utilizes top bars has a trapezoidal shaped cross section in the YZ plane). Also in all embodiments, the hive body 110 has a length L1 sufficient to accommodate more than 10 Langstroth style frames (a Langstroth hive box accommodates a maximum of 10 Langstroth style frames.

As can be seen in FIG. 2A, the hive body 110 has four side walls 11, 12, 13, and 14 connected to form a rectangular wall such that the shape of a rectangular prism without a top side and bottom side is formed. A first pair of side walls 11 and 14 are parallel to one another, and a second pair of side walls 12 and 13 are parallel to one another. FIG. 2A shows each of the first pair of side walls 11 and 14 has a length that is greater than a length of second pair of side walls 12 and 13. Side walls 11, 12, 13, and 14 each have the same height. Each side wall 11 and 14 is connected to side wall 12 and 13, and vice versa.

Each of the first pair of side walls 11 and 14 has a rabbet 111 formed in the top inside edge 112 of the respective side wall 11 and 14. In some embodiments, the dimensions of the rabbet 111 for each side wall 11 and 14 are 0.625 inch vertical and 0.375 inch horizontal. The bottom 114 of side wall 13 can have a bee entry port 113 through which bees can enter and exit the bee hive 100. The entrance reducer 150 of FIG. 1 can be placed in the bee entry port 113 and removed as needed. While the bee entry port 113 is illustrated as formed in side wall 13, it is contemplated that the bee entry port 113 can be formed in the bottom of any other side wall 11, 12, and 14. In some embodiments, more than one opening can be formed in any combination of side walls 11, 12, 13, and 14, and an equal number of entrance reducers can be placed in the openings. In some other embodiments, the hive body 110 has a single bee entry port 113 formed on a side wall 12 and 13 that does not have the rabbet 111 formed therein. The bee entry port 113 generally has dimensions sufficient to receive a commercially available entrance reducer.

In embodiments, the width W1 of the hive body 110 may be about the same as the long side of a standard 10-frame Langstroth hive, and the length L1 of the hive body 110 may be about equal to three standard 10-frame Langstroth hive boxes laid side-by-side.

In some embodiments, the height H1 of the hive body 110 can be about 9, 9.5, 10, 10.5, 11, 11.5, or 12 inches; the outer width W1 (including thickness of side walls 11 and 14) can be about 18.5, 18.625, 18.75, 18.875, 19, 19.125, 19.25, 19.375, 19.5, 19.625, 19.75, 19.875, or 20 inches; and the length L1 (including thickness of side walls 12 and 13) can be about 46.75, 47, 47.25, 47.5, 47.75, 48, 48.25, 48.5, 48.75, 49, 49.25, or 49.5 inches.

A thickness of each side wall 11, 12, 13, and 14 can be about 0.125, 0.25, 0.375, 0.5, 0.625, 0.75, 0.875, or 1.0 inches. Accounting for side wall thickness, the dimensions of the space inside in the hive body 110 can have a length of about 46.0, 46.25, 46.5, 46.75, 47, 47.25, 47.5, 47.75, or 48 inches, a width of about 17, 17.5, 18, 18.5, 19, 19.125, 19.25, 19.375, 19.5, 19.625, 19.75, 19.875, or 20 inches, and a height of about 9, 9.5, 10, 10.5, 11, 11.5, or 12 inches.

In an embodiment, the space inside the hive body 110 (i.e., dimensions of the hive body 110 excluding side wall thickness) has a length of about 47.25 inches, a width of about 18.375 inches, and a height of about 10.5 inches. This embodiment is sufficient to hold up to thirty Langstroth frames, thirty Kenya style top bars, or thirty of a combination of Langstroth frame and Kenya style top bars.

In embodiments, the bee entry port 113 can have a height of about 0.25, 0.375, 0.5, 0.625, 0.75, 0.875, or 1 inch; and a width W2 of about 14, 14.125, 14.25, 14.375, 14.5, 14.625, 14.75, 14.875, or 15 inches.

The hive body 110 can be made or machined of any material, including wood, plastic, metal, or a combination thereof.

FIG. 2B is a cross-sectional view of the hive body 110, taken along sight line A-A in FIG. 2A. The cross section is a rectangular shape, and no part of the hive body 110 has a cross-section that is trapezoidal in shape like the hive body structure of a Kenya hive.

Side wall 11 has rabbet 111 (also called a groove) formed in a top 115 of the side wall 11 and into the inside surface 116. Side wall 14 has rabbet 117 (also called a groove) formed in a top 118 of the side wall 14 and into the inside surface 119. The rabbet 111 and rabbet 117 are parallel to one another along the length L of the hive body 110, and form a surface into which the ends or ears of Langstroth frames and top bars rest.

In some embodiments, the rabbet 111 can be formed inward from the inside surface 116 of the side wall 11 for a distance of about 0.25, 0.375, or 0.5 inch and downward from the top 115 of the side wall 11 for a distance of about 0.375, 0.5, 0.675, or 0.75 inch. Similarly, in some embodiments, the rabbet 117 can be formed inward from the inside surface 119 of the side wall 14 for a distance of about 0.25, 0.375, or 0.5 inch and downward from the top 117 of the side wall 14 for a distance of about 0.375, 0.5, 0.675, or 0.75 inch.

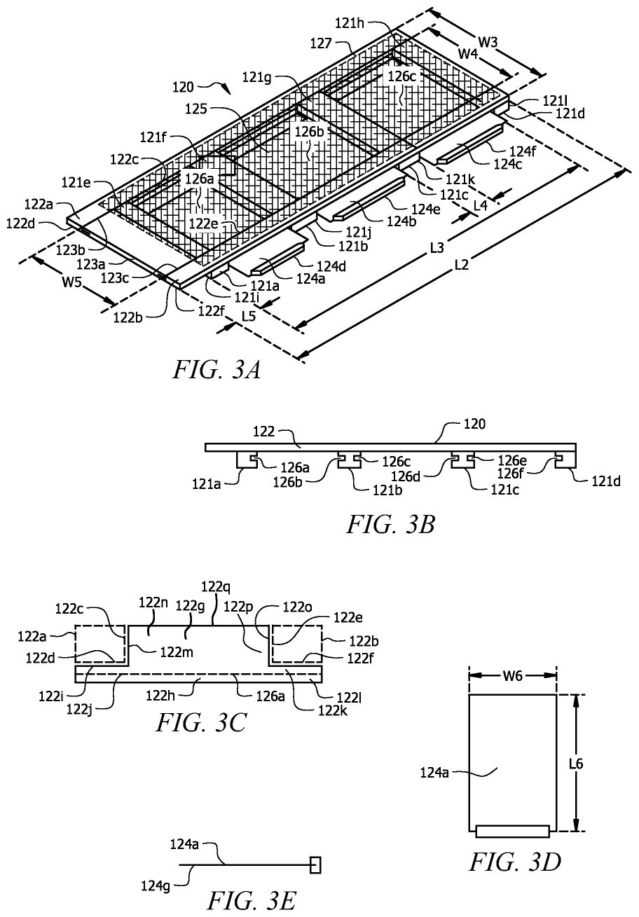

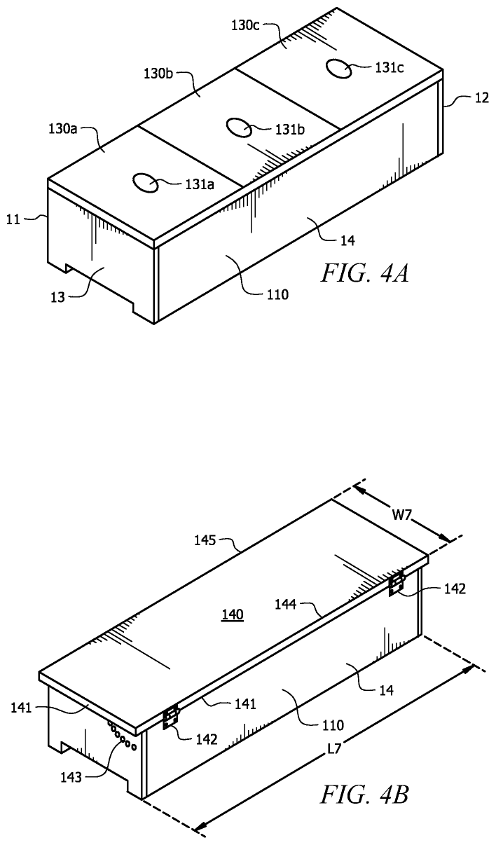

FIG. 3A illustrates an embodiment of the screen bottom board 120 of the disclosed bee hive 100. A perimeter 127 (the dashed lines) on top of the screen bottom board 120 attaches to the bottom surfaces of the side walls 11, 12, 13, and 14 of the hive body 110. The screen bottom board 120 may be longer than the hive body 110 such that a portion 123a, also called the landing board for the bees, extends beyond the hive body 110. A length L2 of the screen bottom board 120 can be about 52, 52.125, 52.325, 52.5, 52.75, 53, 53.25, 53.5, 53.75, 54, 54.25, or 54.5 inches; and a width W3 can be about 17, 17.5, 18, 18.5, 19, 19.125, 19.25, 19.375, 19.5, 19.625, 19.75, 19.875, or 20 inches. In some embodiments, the length L2 can be about 53 inches and the width W3 can be about 18 inches.

The screen bottom board 120 can includes two parallel rails 122a and 122b and four parallel cross members 121a, 121b, 121c, and 121d. Each cross member 121a-d extends perpendicularly with respect to each of the rails 122a-b.

Each cross member 121a-b has an end connected to one of the rails 122 and an opposite end connected to the other of the rails 122. The cross members 121a-d may be spaced equally from one another.

FIG. 3A shows that cross member 121a can have end 121e connected to an inside surface 122c of rail 122a and to a bottom surface 122d of rail 122a. An opposite end 121i of the cross member 121a can be connected to an inside surface 122e of rail 122b and to a bottom surface 122f of rail 122b. Cross member 121b can have end 121f connected to an inside surface 122c of rail 122a and to a bottom surface 122d of rail 122a. An opposite end 121j of the cross member 121b can be connected to an inside surface 122e of rail 122b and to a bottom surface 122f of rail 122b. Cross member 121c can have end 121g connected to an inside surface 122c of rail 122a and to a bottom surface 122d of rail 122a. An opposite end 121k connected to an inside surface 122e of rail 122b and to a bottom surface 122f of rail 122b. Cross member 121d can have end 121h connected to an inside surface 122c of rail 122a and to a bottom surface 122d of rail 122a. An opposite end 121l connected to an inside surface 122e of rail 122b and to a bottom surface 122f of rail 122b.

In some other embodiments, cross member 121a can have end 121e connected to an inside surface 122c of rail 122a and an opposite end 121i connected to an inside surface 122e of rail 122b, cross member 121b can have end 121f connected to an inside surface 122c of rail 122a and an opposite end 121j connected to an inside surface 122e of rail 122b, cross member 121c can have end 121g connected to an inside surface 122c of rail 122a and an opposite end 121k connected to an inside surface 122e of rail 122b, and cross member 121d can have end 121h connected to an inside surface 122c of rail 122a and an opposite end 121l connected to an inside surface 122e of rail 122b. In these embodiments, sub-boards (e.g., mite trays) can be installed from either side of the hive, since the cross members 121a-d are mounted horizontally (i.e., ends are either connected on the inside surfaces 122c and 122e of the rails 122a-b or on the bottom surfaces 122d and 122f of the rails 122a-b). These embodiments have the advantage that sub-boards can be installed from either side of the bee hive.

In some embodiments, each of the cross members 121a-d has a length L4 of about 3, 3.125, 3.25, 3.375, 3.5, 3.625, 3.75, 3.875, or 4 inches. In some embodiments, the length L4 is about 3.5 inches.

The portion 123a of the screen bottom board 120, also called the landing board, can be attached to each rails 122a and 122b. In some embodiments, such as shown in FIG. 3A, the end 123b of the portion 123a can be attached to an inside surface 122c of rail 122a and the end 123c can be attached to an inside surface 122e of rail 122b. In other embodiments, the portion 123a can have ends 122b and 122c attached to bottom surfaces 122d and 122f of rails 122a and 122b, respectively. Attachment can be in any manner, such as nails, screws, adhesive, welds, or a combination thereof.

In embodiments, the portion 123a can have a length L5 of about 4, 4.125, 4.25, 4.375, 4.5, 4.625, 4.75, 4.875, or 5 inches and a width W5 of about 15.5, 15.625, 15.75, 15.875, 16, 16.125, 16.25, 16.375, or 16.5 inches. In an embodiment, the length L5 is about 4.25 inches and the width W5 is about 15.875 inches.

A screen 125 can be placed on a top side of the screen bottom board 120 with one-eighth inch grid attached to the top side of the rails 122a-b and cross members 121a-d. Generally, the screen 125 is sized to cover the spaces 126a-c that are formed between the rails 122a-b and cross members 121a-d. Also, the screen 125 is sized to fit within the boundaries of the perimeter 127 where the hive body 110 attaches to the screen bottom board 120, so that the screen 125 is not between the side walls 11, 12, 13, and 14 of the hive body 110 and the rails 122a and 122b of the screen bottom board 120, so that there is no space between the hive body 110 and screen bottom board 120 through which bees or animals can pass. In some embodiments, the screen 125 can have a width W3 of about 16, 16.5, 17, 17.5, 18, 18.5, 19, 19.5, or 20 inches and a length L3 of about 42, 42.5, 43, 43.5, 44, 44.5, 45, 45.5, 46, 46.5, 47, 47.5, or 48 inches. In one embodiment, the length L3 is about 46 inches and the width W4 is about 18 inches. In some embodiments, the screen 125 can have a 4, 6, 8, or 10 mesh. The mesh size is generally chosen so that mites (e.g., Varroa mites) that fall off bees in the bee hive 100 can fall through the holes in the screen 125, while bees (e.g., honeybees) are too big to pass the through screen holes.

The screen bottom board 120 in FIG. 3A is configured with spaces 126a-c formed between the rails 122a-b and cross members 121a-d that can provide ventilation of outside air to the inside of the hive body 110 of the bee hive 100, even when the screen bottom board 120 is attached to the hive body 110. This configuration of the screen bottom board 120 reduces or negates the need for vent holes in the top cover (see FIG. 4) of the bee hive 100.

Sub-boards are optionally included with the screen bottom board 120. FIG. 3A illustrates three sub-boards 124a-c are included in the screen bottom board 120. The sub-boards 120a-c are held in the screen bottom board 120 by slots 126a-f formed in the cross members 121a-d (see FIG. 3B). Each sub-board 124a-c is a flat sheet of material (e.g., metal, plastic, wood, or a combination thereof), that is sized to be slightly larger in area than the openings 126a-c. Each sub-board 124a-c can optionally include a handle 124d-f. Each handle 124d-f can be configured to make insert and removal of the trays 124a-c easier than if the handle 124d-f were not included. The handles 124d-f can be attached to the trays 124a-c in any manner.

Generally, each sub-board 124a-c functions as a mite tray, i.e., to catch mites that fall through the screen 125 from bees in the bee hive 100. In some embodiments, one or more of the sub-boards 124a-c include a layer of an adhesive material on a side that faces the screen 125 when installed on the screen bottom board 120. The adhesive material may include tar, adhesive, double-sided tape, honey, molasses, or other material onto which mites that fall through the screen 125 can get stuck and cannot escape. “Adhesive material” as used herein can include more than classic adhesives, so long as the material can be deposited in a layer on the sub-boards 124a-c and so long as the material sticks to mites.

The sub-boards 124a-c can have additional functionality besides just collecting mites. In some embodiments, one or more of sub-boards 124a-c can include a layer of insulation material of a side of the sub-board 124a-c that is opposite the side that faces the screen 125. Insulation material can provide insulation from cold temperatures to the bees in the bee hive 100 when the sub-boards 124a-c are installed in the screen bottom board 120.

FIG. 3C illustrates an isolated side view of a cross member 121a, which is representative of the configuration of all the cross members 121a-d. The rails 122a and 122b are illustrated with dashed lines. As can be seen, in order to connect to both the inside surfaces 122c and 122e and bottom surfaces 122d and 122f of rails 122a and 122b, the cross member 121a has a top portion 122g and a bottom portion 122h. The bottom surface 122d of rail 122a connects to a top surface 122i on the end 122j of the bottom portion 122h, and the bottom surface 122f of rail 122b connects to a top surface 122k on the opposite end 122l of the bottom portion 122h. The inside surface 122c of rail 122a connects to a side surface 122m on end 122n of the top portion 122g. The inside surface 122e of rail 122b connects to a side surface 122o on opposite end 122p of the top portion 122g. A top surface 122q of the top portion 122g attaches to the screen 125.

The top portion 122g of the cross member 122a has the same thickness as the rails 122a and 122b so that a continuous surface is formed by the top of the rails 122a and 122b and the top surface 122q. This allows for a flat, continuous surface to which the screen 125 can be attached. It has been found that providing the continuous surface prevents the screen 125 from sagging between the rails 122a and 122b, strengthens the connection of the screen 125 to the screen bottom board 120, and better resists predatory animals' efforts to break into the hive 100 through the screen bottom board 120.

It has also been found that providing the top portion 122g and bottom portion 122h of the cross member 121a creates two points of contact (top surface 122i and side surface 122m for rail 122a; and top surface 122k and side surface 122o for rail 122b) for connecting the rails 122a and 122b to each cross member 121a. Two points of contact strengthens the connection of the cross member 121a to the rails 122a and 122b, and better resists predatory animals' efforts to break into the hive 100 through the screen bottom board 120.

FIG. 3D illustrates a top view of sub-board 124a used in the screen bottom board 120 of FIG. 3A, and FIG. 3E illustrates a side view of the sub-board 124a.

The sub-boards 124a-c can be installed to catch mites over a period of time, and to allow the bee keeper to count the mites caught over the period of time. Counting mites over the period of time can give the bee keeper an idea of the level of infestation, if any, of mites in the bee hive 100. The trays 124a-c can also be installed for the additional purpose of preventing cold air from blowing into the bee hive 100 through the openings 126a-c. In some embodiments, each sub-board 124a-c can include insulation material on a bottom side (e.g., bottom side 124g in FIG. 3E) thereof, to provide insulation from cold temperatures when the trays 124a-c are installed in the screen bottom board 120.

In some embodiments, each sub-board 124a-c can have a length L6 of about 19, 19.125, 19.25, 19.375, 19.5, 19.625, 19.75, 19.875, 20, 20.125, 20.25, 20.375, or 20.5 inches and a width W6 of about 13, 13.125, 13.25, 13.375, 13.5, 13.625, 13.75, 19.875, or 20 inches. In some embodiments, the length L6 is about 19.875 inches and the width W6 is about 13.5 inches.

FIG. 4A shows an orthogonal view of the hive body 110 having the inner covers 130a-c placed on a top thereof. The inners covers 130a-c are placed side by side. While three inner covers 130a-c are shown in FIG. 4A (and also in FIG. 1), it is contemplated that any number of inner covers can be utilized, so long as the total length of the inner covers when placed side by side on the top of the hive body 110 is equal to or about equal to the length L1 of the hive body 110. In some embodiment, each inner cover 130a-c can have a hole 131a-c formed therein. The size of the hole 131a-c is suitable for bees to pass in and out of the hole 131a-c.

In some embodiments, each inner cover 130a-c is a standard 10-frame Langstroth inner cover.

FIG. 4B shows an orthogonal view of the hive body 110 of the bee hive 100 having a top cover 140 placed over a top of the inner covers 130a-c of FIG. 4A. The top cover 140 can also be referred to as a long cover or because it covers the entire length L1 of the hive body 110 of the bee hive 100. In some cases, the top cover 140 is called a telescoping cover. In some embodiments, a length L7 of the top cover 140 can be about 47, 47.125, 47.25, 47.375, 47.5, 47.625, 47.75, 47.875, or 48 inches and a width W7 of the top cover 140 can be about 20, 20.125, 20.25, 20.375, 20.5, 20.625, 20.75, 20.875, or 21 inches. In an embodiment, the length L7 is 47.75 inches and the width W7 is 20.5 inches.

In some embodiments, the top cover 140 can have trim 141 that extends downwardly from all four sides of the top cover 140 so as to hang over the top of the hive body 110 and down along the side walls 11, 12, 13, and 14 of the hive body 110.

In some embodiments, the top cover 140 can be attached to the hive body 110 with hinges 142. A lift mechanism 143 (e.g., short chain, gas spring, hydraulic hinge) can be attached to the side of the top cover 140 and to the hive body 110. A bee keeper can open the top cover 140 by lifting side 145 of the top cover 140, causes the side 144 of the top cover 140 having the hinges 142 to pivot relative to the side wall 14 of the hive body 110. The lift mechanism 143 can prevent the top cover 140 from being opened greater than a particular angle, e.g., stopping the top cover 140 when an angle between the top cover 140 and horizontal is in a range of about 90 to about 170 degrees. A preferable angle is that which would prevent the bee hive 100 from tipping over. An advantage of the hinge and chain or hydraulic rod feature is the top cover 140 does not have to be physically removed from the bee hive 100 when performing inspections and manipulation of hive frames or top bars. Moreover, the top cover 140 can provide a weather proof protection for the bee hive 100, since there are not holes in the top cover 140 (e.g., because ventilation can be provided by the screen bottom board 120). Further, the bees can propolize, or seal, the points of contact between the inner covers 130a-c and the hive body 110 and render the bee hive 100 weatherproof, for added protection of the bees whenever the top cover 140 is opened and closed.

In alternative to using the top cover 140 and inner covers 130a-c, the bee hive 100 can include a plurality of migratory covers. The migratory covers are discussed with references to FIGS. 5A, 5B, and 5C. FIG. 5A illustrates an orthogonal view of a migratory cover 500a for the bee hive 100, FIG. 5B illustrates a side view of the migratory cover 500a, and FIG. 5C illustrates an orthogonal view of the hive body 110 of the bee hive 100, and migratory covers 500a-c on top of the hive body 110. While the embodiment in FIG. 5C shows three migratory covers 500a-c, it is contemplated that the disclosed bee hive may have any number of migratory covers. Whatever the number of migratory covers, it is contemplated that the migratory covers are placed side-by-side over so that the entire length of the hive body 110 is covered by the migratory covers.

Each migratory cover has lips on the end thereof that cover a top portion of the two long side walls 11 and 14 of the hive body 110, while side walls 12 and 13 (the short side walls) are not covered by the migratory covers. In FIG. 5C, end 501 of the first migratory cover 500a has a lip 503 extending vertically downward so that the lip 503 covers the top of side wall 14 of the hive body 110, and end 502 of the first migratory cover 500a has a lip 504 extending vertically downward so that the lip 504 covers the top of side wall 11 of the hive body 110. End 505 of the second migratory cover 500b has a lip 507 extending vertically downward so that the lip 507 covers the top of side wall 14 of the hive body 110, and end 506 of the second migratory cover 500b has a lip 508 extending vertically downward so that the lip 508 covers the top of side wall 11 of the hive body 110. End 509 of the third migratory cover 500c has a lip 511 extending vertically downward so that the lip 511 covers the top of side wall 14 of the hive body 110, and end 510 of the third migratory cover 500c has a lip 512 extending vertically downward so that the lip 512 covers the top of side wall 11 of the hive body 110.

In the side-by-side arrangement shown in FIG. 5C, side 514 of migratory cover 500a is placed next to side 515 of migratory cover 500b, and side 516 of migratory cover 500b is placed next to side 517 of migratory cover 500c. None of sides 513, 514, 515, 516, 517, and 518 has a lip.

In some embodiments, the migratory covers can be commercially available migratory covers. The use of migratory covers with the bee hive 100 instead of the top cover allows access to sections of the bee hive 100 without opening the entire bee hive 100 (as is required for embodiments having a top cover). Moreover, the weight of each migratory cover is significantly less than the top cover, making opening the migratory covers one at a time easier than opening the top cover.

FIG. 6A shows an orthogonal view of the hive body 110 of the bee hive 100 having a plurality of top bars 160 placed therein. Top bars 160, which can also be called top bar frames or top bar style frames, can be moved or removed as needed for inspections, manipulation for the health of the bees, or placement in a different section of the bee hive 100 to be reserved for honey production. In embodiments, the hive body 110 can accommodate at least one top bar 160. In some embodiments, the number of top bars 160 that can be placed in the hive body 110 can be at least 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 top bars 160 and less than 100, 99, 98, 97, 96, 95, 94, 93, 92, 91, 90, 89, 88, 87, 86, 85, 84, 83, 82, 81, 80, 79, 78, 77, 76, 75, 74, 73, 72, 71, 70, 69, 68, 67, 66, 65, 64, 63, 62, 61, 60, 59, 58, 57, 56, 55, 54, 53, 52, or 51 top bars 160. In some embodiments, the number of top bars 160 in the hive body 110 can be from 0 to 30.

The ends or ears 161 and 162 of the top bars 160 rest on the rabbets 111 and 112 formed into the inside top edge of the two long side walls 11 and 14 of the hive body 110. In some embodiments, the top of the top bars 160 is flush with the top of the side walls 11 and 14 of the hive body 110. Advantageously, the top bars 160 can be moved in the hive body 110 or removed as from the hive body 110 needed for inspections, manipulation for the health of the bees, or placement in a different section of the bee hive 100 (e.g., a second to be reserved for honey production, etc.).

While only top bars 160 are shown in the hive body 110 in FIG. 6A, an advantage of the disclosed bee hive 100 is that one or more top bars 160 can be used in the hive body 110 in combination with one or more Langstroth frames 170.

FIG. 6B shows an orthogonal view of the hive body 110 of the bee hive 100 having a plurality of Langstroth frames 170 placed therein. The Langstroth frames 170 can be moved or removed as needed for inspections, manipulation for the health of the bees, or placement in a different section of the bee hive 100. In embodiments, the hive body 110 can accommodate at least one Langstroth frame 170. In some embodiments, the number of Langstroth frames 170 that can be placed in the hive body 110 can be at least 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 Langstroth frames 170 and less than 100, 99, 98, 97, 96, 95, 94, 93, 92, 91, 90, 89, 88, 87, 86, 85, 84, 83, 82, 81, 80, 79, 78, 77, 76, 75, 74, 73, 72, 71, 70, 69, 68, 67, 66, 65, 64, 63, 62, 61, 60, 59, 58, 57, 56, 55, 54, 53, 52, or 51 Langstroth frames 170. In some embodiments, the number of Langstroth frames 170 in the hive body 110 can be from 0 to 30.

The ends or ears 171 and 172 of the Langstroth frames 170 rest on the rabbets 111 and 112 formed into the inside top edge of the two long side walls 11 and 14 of the hive body 110. In some embodiments, the top of the Langstroth frames 170 is flush with the top of the side walls 11 and 14 of the hive body 110. Advantageously, the Langstroth frames 170 can be moved in the hive body 110 or removed as from the hive body 110 needed for inspections, manipulation for the health of the bees, or placement in a different section of the bee hive 100 (e.g., a second to be reserved for honey production, etc.).

While only Langstroth frames 170 are shown in the hive body 110 in FIG. 6B, an advantage of the disclosed bee hive 100 is that one or more top bars 160 can be used in the hive body 110 in combination with one or more Langstroth frames 170.

FIG. 7 is an orthogonal view of a follower board 180 in use in an assembled hive body 110 and screen bottom board 120. The follower board 180 can be used in the hive body 110 (and the bee hive 100) to limit the bees from having too much space to protect. That is, the follower board 180 functions as a partition between two sections 700 and 701 of the hive body 110. Use of the follower board 180 is advantageous when the bee colony is not as big as the hive body 110 of the bee hive 100.

Ears or ends 181 and 182 of the follower board 180 are configured to in the rabbets 111 and 112 of side walls 11 and 14 of the hive body 110, respectively. The follower board 180 is also configured to be moved in the direction of arrows A1 and A2, in directions that are parallel to the side walls 11 and 14. In a scenario where a bee colony is started in section 700 of the hive, with follower board 180 being initially placed in the location shown in FIG. 7, the hive body 110 and follower board 180 are configured so that the follower board 180 can be moved in direction of arrow A2 to create more space for additional top bar(s) 160 and/or Langstroth frame(s) 170, such that section 700 is larger and section 701 is smaller. Once the colony grows to the entire size of the hive body 110, the follower board 180 can be removed from the hive body 110.

In embodiments, the follower board 180 can be constructed of wood, metal, plastic or a combination thereof. Dimensions of the follower board 180 are configured to prevent bees from moving from section 700 of the hive body 110 to section 701 of the hive body 110 where the escaped bees might build unwanted honeycomb. That is, dimensions of the follower board 180 are configured to prevent bees from moving from moving from side 702 of the follower board 180 to an opposite side 703 of the follower board 180.

The follower board 180 generally is constructed of a top board 704 and a bottom board 705 connected to the top board 704. The top board 704 is the part of the follower board 180 having the ends or ears 181 and 182 that hold the follower board 180 in the rabbets 111 and 112 of the hive body 110. The bottom board 705 is a solid piece of the material(s) of construction configured to be the partition of the follower board 180 that prevents bees from moving from section 700 to section 701 of the hive body 110.

The top board 704 can have a width W8 of about 18, 18.5, 19, 19.5, or 20 inches, and a height H2 of about 0.5, 0.625, 0.75, 0.875, or 1 inch. The bottom board 705 can have a width W9 of about 17.5, 18, 18.5, or 19 inches and a height H3 of about 9.5, 9.625, 9.75, 9.875, or 10 inches. The thicknesses of the top board 704 and the bottom board 705 can be the same or different. In embodiments, the thickness of the top board 704 can be 0.5, 0.625, 0.75, 0.875, 1, 1.125, 1.25, 1.375, or 1.5 inches. In embodiments, the thickness of the bottom board 705 can be 0.25, 0.375, 0.5, 0.625, 0.875, or 1 inch.

In an embodiment, the top board 704 has a width W8 of about 19 inches, a height H2 of about 0.625 inch, and a thickness of about 1 inch; and the bottom board 705 has a width W9 of about 18 inches, a height H3 of about 9.875 inches, and a thickness of about 0.75 inches.

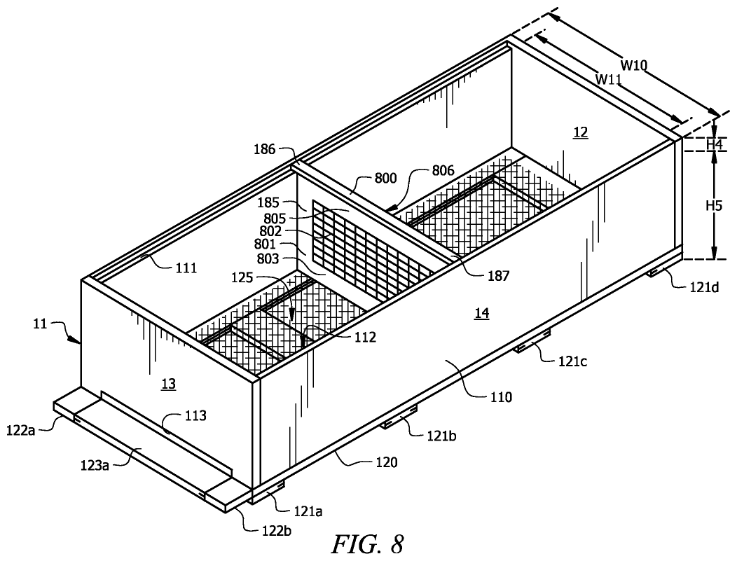

FIG. 8 is an orthogonal view of a queen excluder 185 in use in an assembled hive body 110 and screen bottom board 120. The queen excluder 185 can be used in the hive body 110 (and the bee hive 100) to separate brood frames (top bars(s) 160 and/or Langstroth frame(s) 170 configured by the bees as brood frames) and honey frames (top bars(s) 160 and/or Langstroth frame(s) 170 configured by the bees for honey production) to prevent the queen from laying eggs in the honey frames that will be harvested for honey.

The queen excluder 185 generally is constructed of a top board 800 and a bottom board 801 connected to the top board 800. The top board 800 is the part of the queen excluder 185 having the ends or ears 186 and 187 that hold the queen excluder 185 in the rabbets 111 and 112 of the hive body 110. The bottom board 801 is a solid piece of the material(s) of construction configured with a mesh window 802 in a solid portion 803. The solid portion 803 is solid, and no bees can pass through the solid portion 803 from side 805 of queen excluder 185 to opposite side 806 of the queen excluder 185, and vice versa. The mesh window 802 is configured with a metal or plastic mesh that is sized with mesh holes that prevent the queen bee from moving through the window 802 while allowing other bees to pass through the window 802 (e.g., from side 805 to side 806, or from side 806 to side 805).

The top board 800 can have a width W10 of about 18, 18.5, 19, 19.5, or 20 inches, and a height H4 of about 0.5, 0.625, 0.75, 0.875, or 1 inch. The bottom board 801 can have a width W11 of about 17.5, 18, 18.5, or 19 inches and a height H5 of about 9.5, 9.625, 9.75, 9.875, or 10 inches. The thicknesses of the top board 800 and the bottom board 801 can be the same or different. In embodiments, the thickness of the top board 800 can be 0.5, 0.625, 0.75, 0.875, 1, 1.125, 1.25, 1.375, or 1.5 inches. In embodiments, the thickness of the bottom board 801 can be 0.25, 0.375, 0.5, 0.625, 0.875, or 1 inch.

In an embodiment, the top board 800 has a width W10 of about 19 inches, a height H4 of about 0.625 inch, and a thickness of about 1 inch; and the bottom board 801 has a width W11 of about 18 inches, a height H5 of about 9.875 inches, and a thickness of about 0.75 inches.

The solid portion 803 can be constructed metal, plastic, wood, or a combination thereof.

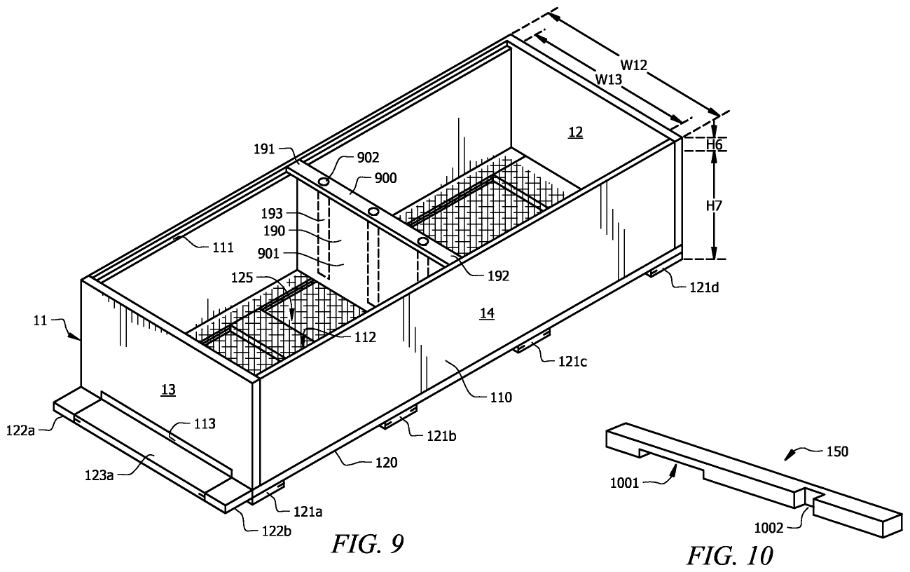

FIG. 9 is an orthogonal view of a division board feeder 190 in use in an assembled hive body 110 and screen bottom board 120. The division board feeder 190 has one or more reservoir(s) 193 (show with dashed lined) that hold food for the bees (e.g., sugar syrup). The division board feeder 190 can be placed strategically in the hive body 110 so that bees from the colony can access the food.

The division board feeder 190 generally is constructed of a top board 900 and a bottom board 901 connected to the top board 900. The top board 900 is the part of the division board feeder 190 having the ends or ears 191 and 192 that hold the division board feeder 190 in the rabbets 111 and 112 of the hive body 110. The bottom board 901 is a solid piece of the material(s) of construction configured with the reservoir(s) 193 formed therein.

The top board 900 can have a width W12 of about 18, 18.5, 19, 19.5, or 20 inches, and a height H6 of about 0.5, 0.625, 0.75, 0.875, or 1 inch. The bottom board 901 can have a width W13 of about 17.5, 18, 18.5, or 19 inches and a height H7 of about 9.5, 9.625, 9.75, 9.875, or 10 inches. The thicknesses of the top board 900 and the bottom board 901 can be the same or different. In embodiments, the thickness of the top board 900 can be 0.5, 0.625, 0.75, 0.875, 1, 1.125, 1.25, 1.375, or 1.5 inches. In embodiments, the thickness of the bottom board 901 can be 0.25, 0.375, 0.5, 0.625, 0.875, or 1 inch.

In an embodiment, the top board 900 has a width W12 of about 19 inches, a height H6 of about 0.625 inch, and a thickness of about 1 inch; and the bottom board 901 has a width W13 of about 18 inches, a height H7 of about 9.875 inches, and a thickness of about 0.75 inches.

In embodiments, the top board 900 has hole(s) 902 formed therein, wherein each hole 902 fluidly communicates with one of the reservoir(s) 193 in the bottom board 901. This allows a bee keeper to add bee food into the reservoir(s) 193.

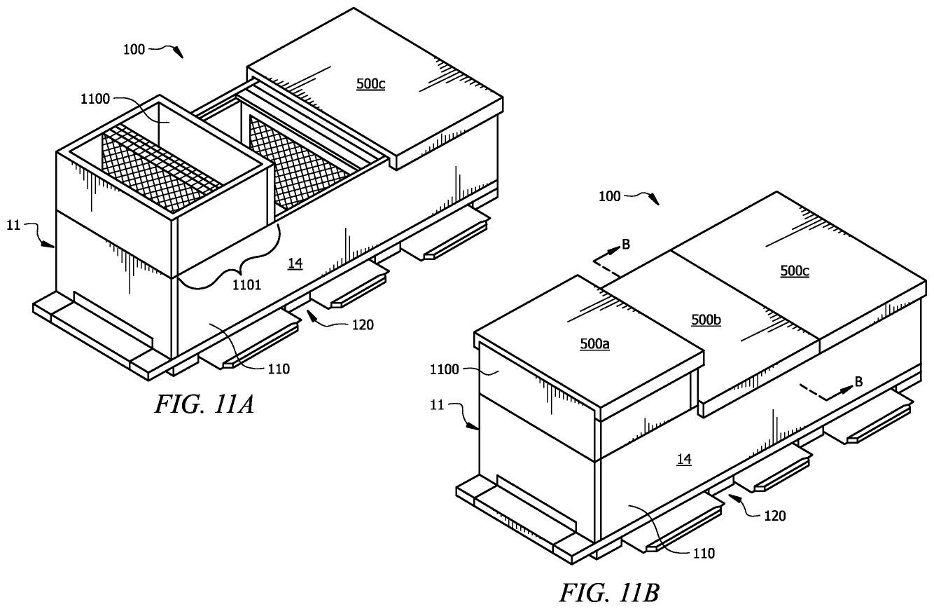

FIG. 10 illustrates an orthogonal view of an entrance reducer 150. The entrance reducer 150 can be configured to have to notches 1001 and 1002 formed therein. As can be seen one notch 1001 is larger than the other notch 1002. Notch 1001 is formed on a side of the entrance reducer 150 that is different than the side in which notch 1002 is formed. Forming notches 1001 and 1002 in this manner allows the entrance reducer 150 to be flipped to whichever notch 1001 or 1002 is desired for the size of the reduced entrance to the bee hive 100. The entrance reducer 150 aids in preventing raiding bees from entering the bee hive 100 by making the entrance small enough that the guard bees can control access to the colony in the bee hive 100. Entrance reducers like entrance reducer 150 are commercially available in dimensions that fit the bee entry port 113 of the hive body 110.

FIGS. 11A and 11B are orthogonal views of the disclosed bee hive 100 having a Langstroth top feeder 1100. Langstroth top feeders 1100 are commercially available and are not described in detail except in relation to the disclosed bee hive 100. As can be seen, the bee hive 100 can receive at least Langstroth top feeder 110 on a top of at least one section 1101 of the hive body 110 of the bee hive 100. In such embodiments, the outer covers that are used are the migratory covers 500a-c of FIGS. 5A to 5C, since a single top cover 140 is not possible due to the presence of the top feeder 1100. In embodiments of the bee hive 100 which utilize a top feeder 1100 on a section 1101 of the hive body 110, the migratory cover, in this case migratory cover 500a, can be placed on top of the top feeder 1100, while migratory covers 500b and 500c are placed on the hive body 110 as is discussed in the description for FIGS. 5A to 5C. Sugar syrup levels in the top feeder 110 can be inspected by removing a cover.

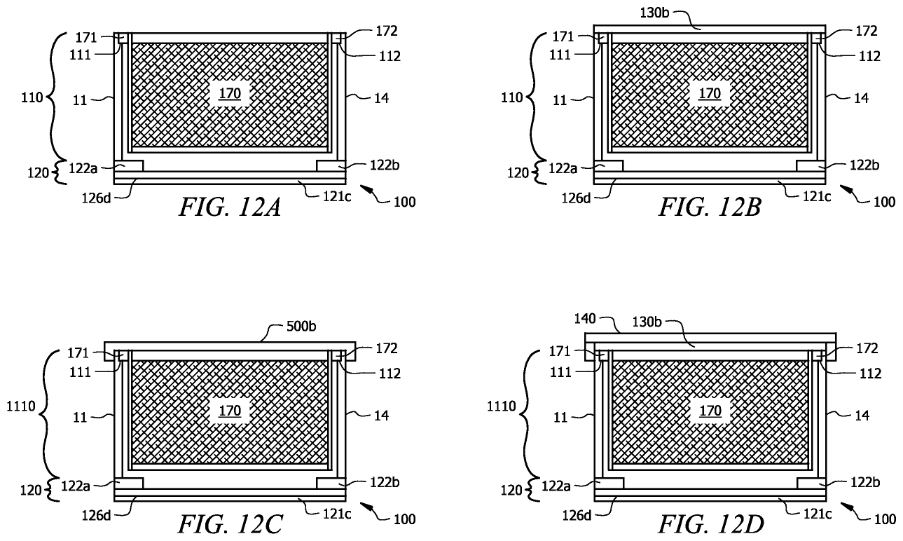

FIGS. 12A to 12D illustrate cross sectional views of the bee hive 100 in different configurations with the different covers (top cover 140, migratory cover 500b, and inner cover 130b), taken along sight line B-B of FIG. 11B.

FIG. 12A shows the hive body 110 and screen bottom board 120 of the bee hive 110, with a Langstroth frame 170 placed therein. The ends or ears 171 and 172 rest on the rabbet 111 and 112 formed in the side walls 11 and 14 of the hive body 110. FIG. 12A is shown without any covers.

FIG. 12B shows the hive body 110 and screen bottom board 120 of the bee hive 110, with a Langstroth frame 170 placed therein. The ends or ears 171 and 172 rest on the rabbet 111 and 112 formed in the side walls 11 and 14 of the hive body 110. FIG. 12B shows the inner cover 130b placed over the top of the hive body 110 (and over the Langstroth frame 170).

FIG. 12C shows the hive body 110 and screen bottom board 120 of the bee hive 110, with a Langstroth frame 170 placed therein. The ends or ears 171 and 172 rest on the rabbet 111 and 112 formed in the side walls 11 and 14 of the hive body 110. FIG. 12C shows the inner cover 130b placed over the top of the hive body 110 (and over the Langstroth frame 170, and additionally shows the migratory cover 500b placed over the inner cover 130b.

FIG. 12D shows the hive body 110 and screen bottom board 120 of the bee hive 110, with a Langstroth frame 170 placed therein. The ends or ears 171 and 172 rest on the rabbet 111 and 112 formed in the side walls 11 and 14 of the hive body 110. FIG. 12D shows the inner cover 130b placed over the top of the hive body 110 (and over the Langstroth frame 170, and additionally shows the top cover 140 placed over the inner cover 130b.

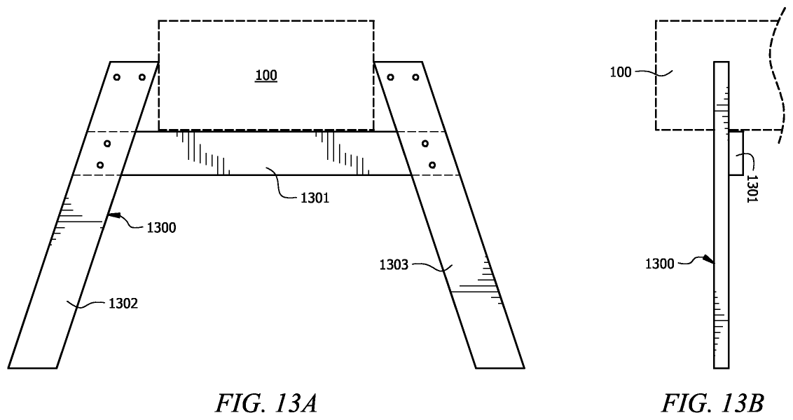

FIG. 13A shows a front view of support legs 1300 for the bee hive 100, and FIG. 13B shows a side of view of the support legs 1300. The bee hive 100 is shown with dashed lines in FIGS. 13A and 13B. The support legs 1300 have a cross bar 1301 that connects two legs 1302 and 1303. Support legs 1300 are commercially available, and the configuration of support legs 1300 is not limited by this disclosure.

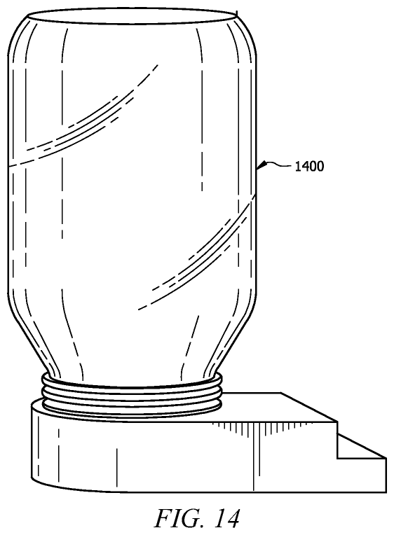

FIG. 14 is an orthogonal view of an embodiment of an entrance feeder 1400. The entrance feeder 1400 is commercially available and the disclosure is not limited to the entrance feeder 1400 shown in FIG. 14. The entrance feeder 1400 can be placed on the portion 123a, or landing board, of the screen bottom board 120 of the bee hive 100. The entrance feeder 1400 thus allows a visual inspection of sugar syrup levels without opening the bee hive 100 (as opposed to the division board feeder 190 which requires opening the bee hive 100 to inspect sugar syrup levels).

This disclosed bee hive 100 allows for the use of the 3 standard Langstroth types of feeders: the division board feeder 190, the entrance feeder 1400, and the top feeder 1100. Thus, bee keepers are not limited to a particular feeder, and can use Langstroth type feeders when using top bars 160 in the bee hive 100, since the bee hive 100 is both Langstroth style and Kenya style compatible.

While embodiments of the disclosure have been shown and described, modifications thereof can be made without departing from the spirit and teachings of the invention. The embodiments and examples described herein are exemplary only, and are not intended to be limiting. Many variations and modifications of the invention disclosed herein are possible and are within the scope of the invention.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, 5, 6, . . . ; greater than 0.10 includes 0.11, 0.12, 0.13, 0.14, 0.15, . . . ). For example, whenever a numerical range with a lower limit, R₁, and an upper limit, Rᵤ, is disclosed, any number falling within the range is specifically disclosed. In particular, the following numbers within the range are specifically disclosed: R=R₁+k* (Rᵤ−R₁), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent . . . 95 percent, 96 percent, 97 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of.

Accordingly, the scope of protection is not limited by the description set out above but is only limited by the claims which follow, that scope including all equivalents of the subject matter of the claims. Each and every claim is incorporated into the specification as an aspect of the present invention. Thus, the claims are a further description and are an addition to the detailed description of the present invention.

I claim:

1. A bee hive comprising:
a hive body comprising a first pair of parallel side walls connected to a second pair of parallel side walls to form a rectangular wall,
wherein each of the first pair of parallel side walls has a length that is greater than a length of each of the second pair of parallel side walls,
wherein each of the first pair of parallel side walls has a rabbet formed in an inside top edge of each of the first pair of parallel side walls,
wherein the rabbets of the first pair of parallel side walls are configured to hold a top bar and configured to hold a frame.

2. The bee hive as set forth in claim 1, wherein one of the second pair of parallel side walls has a bee entry port formed at a bottom thereof.

3. The bee hive as set forth in claim 2, further comprising an entrance reducer placed in the bee entry port.

4. The bee hive as set forth in claim 1, further comprising a screen bottom board, wherein the screen bottom board comprises:
two parallel rails;
a plurality of cross members, wherein each of the plurality of cross members is connected to each of the two parallel rails,
wherein the two parallel rails are each perpendicular to the plurality of cross members; and
a screen placed over openings in the screen bottom board that are formed between the two parallel rails and the plurality of cross members.

5. The bee hive as set forth in claim 4, further comprising one or more removable sub-boards, wherein each of the one or more removable sub-boards is placed between two of the plurality of cross members and below the screen.

6. The bee hive as set forth in claim 5, wherein each of the one or more removable sub-boards has a layer of an adhesive material on a side thereof that faces the screen.

7. The bee hive as set forth in claim 5, wherein each of the one or more removable sub-boards has insulation on a first side that is opposite of a second side of each of the one or more removable sub-boards that faces the screen.

8. The bee hive as set forth in claim 4, wherein each of the plurality of cross members comprises:
a top portion having a first side surface on an end thereof, a second side surface on an opposite end thereof, and a top surface; and
a bottom portion having a first top surface on an end thereof and a second top surface on an opposite end thereof.

9. The bee hive as set forth in claim 8, wherein the first side surface of the top portion and the first top surface of the bottom portion connect to a first rail of the two parallel rails, and wherein the second side surface of the top portion and the second top surface of the bottom portion connect to a second rail of the two parallel rails.

10. The bee hive as set forth in claim 8, wherein the screen is connected to the top surface of the top portion.

11. The bee hive as set forth in claim 10, wherein the screen is connected to the two parallel rails.

12. The bee hive as set forth in claim 11, wherein the top portion and the two parallel rails have the same thickness so that a continuous surface is formed by a top of the two parallel rails and the top surface, and the screen is attached to the continuous surface.

13. The bee hive as set forth in claim 1, wherein the hive body is configured to hold thirty of a combination of top bars and frames.

14. The bee hive as set forth in claim 1, wherein further comprising one or more of a division board feeder placed in the hive body, a top feeder placed on top of a section of the hive body, or an entrance feeder placed on a portion of a screen bottom board.

15. The bee hive as set forth in claim 1, further comprising:
a plurality of inner covers placed over a top of the hive body; and
a top cover placed over all of the plurality of inner covers.

16. The bee hive as set forth in claim 15, wherein the top cover comprises a trim extending downwardly from all four sides of the top cover so as to cover a top of each of the first pair and second pair of parallel side walls of the hive body.

17. The bee hive set forth in claim 15, further comprising hinges connecting the top cover to one side wall of the first pair of parallel side walls, and a lift mechanism connecting the top cover to one side wall of the second pair of parallel side walls.

18. The bee hive as set forth in claim 1, further comprising:
a plurality of inner covers placed over a top of the hive body; and
a plurality of migratory covers, wherein each of the plurality of migratory covers is placed over one of the inner covers.

19. The bee hive as set forth in claim 18, wherein each of the plurality of migratory covers has a lip on each side thereof, wherein no lip of any of the migratory covers extends over the second pair of parallel side walls of the hive body.

20. The bee hive as set forth in claim 1, wherein the rabbet in each of the first pair of parallel side walls has dimensions of 0.625 inch vertical and 0.375 inch horizontal.
